(19) United States
(12) Patent Application Publication
(10) Pub. No.: US 2026/0063890 A1
(43) Pub. Date: Mar. 5, 2026

(54) IMAGING UNIT, CAMERA HEAD, METHOD FOR MANUFACTURING CAMERA HEAD, AND METHOD FOR ATTACHING IMAGING UNIT

(71) Applicant: TANAKA ENGINEERING INC., Saitama (JP)

(72) Inventors: Motohiro MISAWA, Saitama (JP); Susumu YAGI, Saitama (JP); Yutaka YAMAGATA, Saitama (JP); Hitoshi OKAMOTO, Saitama (JP)

(21) Appl. No.: 19/312,994

(22) Filed: Aug. 28, 2025

(30) Foreign Application Priority Data
Sep. 3, 2024 (JP) 2024-151817

(51) Int. Cl. G02B 23/24

(52) U.S. Cl. CPC G02B 23/2484; G02B 23/243; G02B 23/2469

(57) ABSTRACT

There are demands for an imaging unit that is easy to handle. An imaging unit includes an optical element that is a gradient-index lens, for example, a joint portion fixable to the optical element, and a camera head including a leading end portion that is close to the optical element and through which light from the optical element enters and light is emitted toward the optical element. A male thread is formed around the leading end portion. The joint portion includes an attachment portion into which the male thread is screwed. The leading end portion is disposed inside the joint portion. The imaging unit makes it possible to adjust the distance between the camera head and the gradient-index lens with high precision.

### CROSS-REFERENCE TO RELATED APPLICATIONS

The present application claims priority from Japanese Patent Application No. 2024-151817 filed on Sep. 3, 2024, the entire contents of which are hereby incorporated by reference.

### BACKGROUND OF THE INVENTION

### 1. Field of the Invention

The present invention relates to an imaging unit used for observation of an observation target, a camera head, a method for manufacturing the camera head, and a method for attaching the imaging unit.

### 2. Description of Related Art

Conventionally, various types of camera heads and imaging units in which the camera heads are used have been used in endoscopes for observing living organisms, industrial endoscopes, and the like.

For example, Patent Document 1 below discloses a structure of a camera head that includes an imaging element and a light source housed in the camera head and emits light from a leading end portion and captures incident light from an observation target.

Also, for example, Patent Document 2 below describes a structure of an imaging unit that includes: a lens holder housing a group of objective lenses in a hollow portion; and an imaging holder housing a prism and an imaging element.

Also, for example, Patent Documents 3 to 5 below describe structures of imaging units that use gradient-index lenses (GRIN lenses).

### BACKGROUND ART

### Patent Document

Patent Document 1: JP 7488619B
Patent Document 2: JP 2014-119474A
Patent Document 3: WO17/170662
Patent Document 4: JP 2011-510338A
Patent Document 5: JP 2005-533530A

### SUMMARY OF THE INVENTION

### Problem to be Solved by the Invention

It is important to make an imaging unit that is constituted by multiple components including, for example, a camera head and an optical element for an observation target easier to handle. For example, in an imaging unit that includes a camera head and a gradient-index lens attached to the front of the camera head, it is necessary to attach the lens to a portion of the camera head with high precision to detect light entering from the lens, and it is desirable that the lens be easily attachable to the camera head.

The present invention was made in view of the above circumstances, and has an object of providing an imaging unit that can be easily handled, a camera head, a method for manufacturing the camera head, and a method for attaching the imaging unit.

### Means for Solving the Problems

An imaging unit according to a first aspect of the present invention includes: an optical element; a joint portion fixable to the optical element; and a camera head that includes a leading end portion that is close to the optical element and through which light from the optical element enters and light is emitted toward the optical element, wherein a male thread is formed around the leading end portion, the joint portion includes an attachment portion into which the male thread is screwed, and the leading end portion is disposed inside the joint portion.

This configuration makes it possible to adjust the distance between the camera head and the optical element with high precision and easily handle the imaging unit.

An imaging unit according to a second aspect of the present invention is the imaging unit according to the first aspect, wherein the optical element is a gradient-index lens extending in a longitudinal direction and configured to adjust an optical path between an observation target and the imaging unit, the camera head includes: a camera module that is disposed in the vicinity of the leading end portion; a light source that is disposed behind the camera module; and an optical fiber extending from the light source to the vicinity of the leading end portion, and a leading end portion of the optical fiber includes an emitting portion configured to be capable of emitting at least a portion of light guided from the light source in a direction different from the longitudinal direction of the gradient-index lens.

With this configuration, light from the light source can be efficiently emitted toward the observation target via the gradient-index lens.

An imaging unit according to a third aspect of the present invention is the imaging unit according to the second aspect, wherein the gradient-index lens, the joint portion, and the camera head are lined up along the longitudinal direction of the gradient-index lens, the emitting portion is an inclined portion that is an end surface of the leading end portion of the optical fiber formed to incline with respect to the longitudinal direction of the gradient-index lens, the inclined portion inclining rearward to be away from the leading end portion in the longitudinal direction of the gradient-index lens while extending outward from a center portion of the leading end portion in a direction perpendicular to the longitudinal direction of the gradient-index lens.

With this configuration, light from the light source can be more efficiently emitted toward the observation target via the gradient-index lens.

An imaging unit according to a fourth aspect of the present invention is the imaging unit according to the second aspect, wherein the camera head includes a housing that includes a portion in which the male thread is formed, each unit of the camera head is housed in the housing, and the housing includes: a first tube portion that is a tubular portion close to the leading end portion; a second tube portion that is a tubular portion close to a rear end portion on the side opposite to the leading end portion and in which at least the light source is disposed; and a heat insulating portion that is disposed between the first tube portion and the second tube portion and is made of a material having a thermal conductivity lower than a thermal conductivity of the second tube portion.

According to this configuration, heat generated from the light source is unlikely to be conducted to the leading end portion of the camera head, and the observation target can be prevented from being affected by the heat.

An imaging unit according to a fifth aspect of the present invention is the imaging unit according to the second aspect, wherein the camera head includes a guide that is disposed in the vicinity of the leading end portion and positions the camera module and the optical fiber (in a radial direction).

With this configuration, it is possible to easily assemble the camera head by positioning the camera module and the optical fiber at ideal positions.

An imaging unit according to a sixth aspect of the present invention is the imaging unit according to the second aspect, wherein the camera head includes: a first filter disposed between the light source and the optical fiber; and a second filter disposed such that light entering the camera module passes through the second filter.

This configuration makes it possible to flexibly design the structure of the camera head including the two types of filters.

An imaging unit according to a seventh aspect of the present invention is the imaging unit according to the first aspect, wherein the camera head includes a filter that is disposed in the vicinity of the leading end portion and through which light entering the camera head and light emitted from the camera head pass, and the filter includes: a transparent substrate; a first transmitting portion that is disposed on the substrate and through which light emitted from the camera head passes; and a second transmitting portion that is disposed on the substrate and through which light entering the camera head passes.

With this configuration, it is possible to configure a small camera head by disposing the two types of filters on the same substrate.

An imaging unit according to an eighth aspect of the present invention is the imaging unit according to the first aspect, wherein the optical element extends in the longitudinal direction and includes a rear end portion and a side surface, and the optical element includes a guide member that is disposed in the vicinity of the rear end portion of the optical element and configured to cause a portion of light emitted from the leading end portion of the camera head to enter the side surface of the optical element.

This configuration enables light from the light source to efficiently enter the optical element.

An imaging unit according to a ninth aspect of the present invention is the imaging unit according to the eighth aspect, wherein the guide member includes a reflecting portion that reflects light entering from behind inward toward the side surface of the optical element in a portion forward of the rear end portion of the optical element.

This configuration enables light from the light source to efficiently enter the optical element.

An imaging unit according to a tenth aspect of the present invention is the imaging unit according to the first aspect, wherein the optical element is a member extending in the longitudinal direction and includes a fixing member attached to an end portion of the optical element close to the camera head in the longitudinal direction, a groove portion is formed in an outer circumferential portion of the fixing member, the optical element is attached to the joint portion such that a contact surface of the fixing member in the longitudinal direction is in contact with part of the joint portion and the outer circumferential portion faces part of the joint portion, and an adhesive is disposed between the groove portion and the joint portion.

With this configuration, it is possible to set the positional relationship between the optical element and the joint portion in the longitudinal direction with high precision and reliably fix the joint portion to the optical element.

A camera head according to an eleventh aspect of the present invention is a camera head usable in the imaging unit according to the first aspect, the camera head including: a housing; and a camera module provided in the vicinity of a leading end portion of the housing, wherein the male thread capable of being screwed into the attachment portion of the joint portion is formed around the leading end portion of the housing.

With this configuration, it is possible to provide a camera head that can be used by easily attaching an optical element.

A method for manufacturing a camera head according to a twelfth aspect of the present invention is a method for manufacturing a camera head including: a male thread capable of being screwed into a joint portion of an imaging unit; and a filter disposed in the vicinity of a leading end portion to which the joint portion is attached, the camera head being configured such that light that has passed through a first transmitting portion included in the filter is emitted toward the joint portion and light entering from the joint portion passes through a second transmitting portion included in the filter, the method including: preparing a first member including the first transmitting portion; preparing a second member including the second transmitting portion; partially disposing the first member and the second member on a transparent substrate; cutting the substrate on which the first member and the second member has been disposed into a shape of the filter; and disposing the cut filter in the vicinity of the leading end portion.

With this configuration, it is possible to easily and reliably manufacture the camera head including the filter including the two types of transmitting portions.

An imaging unit attaching method according to a thirteenth aspect of the present invention is a method for attaching the imaging unit according to any one of the first through tenth aspects to a test target organism, the method including: fixing the joint portion to the optical element; attaching the optical element to a test target organism; and attaching the camera head to the joint portion by screwing the leading end portion of the camera head into the attachment portion of the joint portion.

With this configuration, it is possible to easily dispose the optical element at an appropriate position and perform observation with use of the camera head.

An imaging unit attaching method according to a fourteenth aspect of the present invention is the method according to the thirteenth aspect, further including fixing a stopper to a position spaced apart from a leading end portion of the optical element rearward by a predetermined distance, and in the attaching the optical element to a test target organism, the optical element is attached to the test target organism such that the stopper is located at a predetermined position relative to the test target organism.

With this configuration, it is possible to easily dispose the optical element at an appropriate position.

An imaging unit attaching method according to a fifteenth aspect of the present invention is the method according to the thirteenth aspect, wherein a fixing member is attached to an end portion of the optical element, a groove portion is formed in an outer circumferential portion of the fixing member, and the fixing the joint portion includes introducing an adhesive between the joint portion and the groove portion from a hole provided in the joint portion in a state where the outer circumferential portion of the fixing member is inside the joint portion.

With this configuration, it is possible to reliably fix the joint portion to the optical element.

An imaging unit attaching method according to a sixteenth aspect of the present invention is the method according to the thirteenth aspect, wherein the attaching the camera head to the joint portion includes adjusting a position of the camera head relative to the joint portion such that a desired light emitting state or a desired light entering state is achieved between the optical element and the camera head, and fixing the position of the camera head relative to the joint portion with a fixing part.

With this configuration, it is possible to easily dispose the optical element at an appropriate position and reliably perform observation with use of the camera head.

### Advantageous Effects of the Invention

According to the present invention, it is possible to make an imaging unit easy to handle.

### BRIEF DESCRIPTION OF THE DRAWINGS

FIG. 1 is a diagram illustrating a configuration of an imaging system according to one embodiment of the present invention.

FIG. 2 is a block diagram of the imaging system.

FIG. 3 is a cross-sectional side view of an imaging unit.

FIG. 4 is a cross-sectional view taken along a line A-A in FIG. 3.

FIG. 5 is a cross-sectional view taken along a line C-C in FIG. 3.

FIG. 6 is an enlarged cross-sectional side view of the vicinity of a joint portion of the imaging unit.

FIG. 7 is a diagram illustrating the imaging unit as viewed from a leading end side in a longitudinal direction.

FIG. 8 is a side view of a fixing member of an optical element.

FIG. 9 is a diagram illustrating a configuration of a filter of the camera head.

FIG. 10 is a diagram illustrating an example of a method for manufacturing the filter.

FIG. 11 is a first diagram illustrating a method for manufacturing the imaging unit.

FIG. 12 is a second diagram illustrating the method for manufacturing the imaging unit.

FIG. 13 is a diagram illustrating the joint portion of the imaging unit as viewed from a rear end side in the longitudinal direction.

FIG. 14 is a diagram illustrating a use example of the imaging system according to the present embodiment.

FIG. 15 is a first diagram illustrating an example of a method for attaching the imaging unit to a test target organism.

FIG. 16 is a second diagram illustrating the example of a method for attaching the imaging unit to a test target organism.

FIG. 17 is a cross-sectional side view of an imaging unit according to Embodiment 2 of the present invention.

### DETAILED DESCRIPTION OF THE INVENTION

Hereinafter, embodiments of an imaging unit and an imaging system using the same, and the like will be described with reference to the drawings. In the embodiments, components with the same reference numerals are configured similarly in general, and therefore repeated explanations may be omitted.

In the following description, a direction orthogonal to the longitudinal direction of a tubular camera head may also be referred to as a radial direction, and a direction along an arc centered around the central axis of the camera head extending in the longitudinal direction may also be referred to as a circumferential direction. In addition, in the following description, the direction toward the leading end portion in the longitudinal direction may also be referred to as a “front” and the opposite direction may also be referred to as a “rear”. For example, the shape and positional relationships of each unit may be described by indicating a particular direction in this way, but the explicit indication of the direction is only for ease of description and does not limit the orientation or posture of each device, etc., according to the present invention when used. In addition, expressions indicating a direction or expressions indicating a state such as horizontal, vertical, orthogonal, etc., only indicate that they can be roughly understood in that way, and do not necessarily have to be interpreted strictly as expressed.

### Embodiment 1

A summary of Embodiment 1 is as follows. In the present embodiment, an imaging unit includes a camera head, a joint portion attached to a leading end portion of the camera head, and an optical element fixable to the joint portion. The joint portion is configured to be capable of being screwed onto the leading end portion of the camera head. For example, a gradient-index lens can be used as the optical element.

The camera head may include a camera module provided in the vicinity of the leading end portion, a light source behind the camera module, and an optical fiber extending from the light source to the vicinity of the leading end portion. A leading end portion of the optical fiber may be an inclined portion so that light enters the optical element more appropriately. Note that the camera head may include a filter through which light from the light source and light entering the camera module pass. A configuration is possible in which filters are respectively disposed between the light source and the optical fiber and at a position through which light entering the camera module passes. Alternatively, a configuration is also possible in which a filter is disposed in the vicinity of the leading end and includes a transmitting portion that is provided on a substrate and through which light emitted from the camera head passes and a transmitting portion that is provided on the substrate and through which light entering the camera head passes.

A housing of the camera head may be configured to include a heat insulating portion between a portion in which the light source is provided and the leading end portion so that heat from the light source is unlikely to be conducted to the leading end portion.

Hereinafter, an imaging unit with such a configuration and an example of the configuration of an imaging system using the imaging unit will be described.

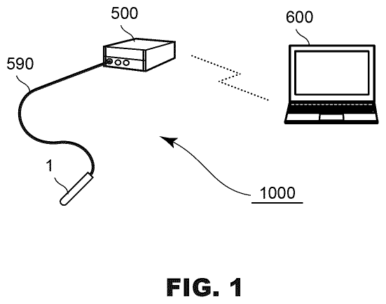

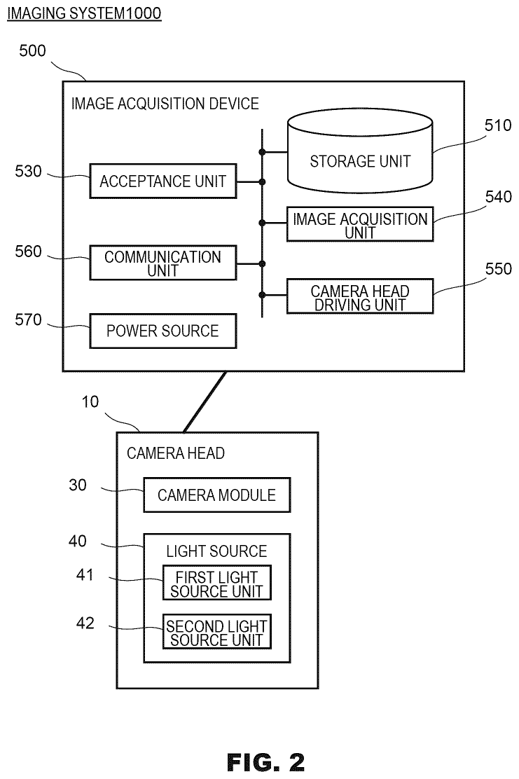

FIG. 1 is a diagram illustrating the configuration of an imaging system 1000 according to one embodiment of the present invention. FIG. 2 is a block diagram of the imaging system 1000.

As shown in the figures, the imaging system 1000 includes an imaging unit 1 including a camera head 10, and an image acquisition device 500. The imaging system 1000 can be used as an endoscope for observing and inspecting various types of tissue and organs of living organisms, an industrial endoscope, or the like. That is to say, the imaging system 1000 can be used in various fields for industrial applications, medical applications, scientific applications, etc. The imaging system 1000 is configured to be capable of acquiring imaging results of an imaging area in the vicinity of the leading end of the imaging unit 1. The imaging system 1000 is configured to be capable of recording the imaging results as images and outputting them to an internal or external output device.

For example, the imaging system 1000 can be used to capture images for acquiring information (hereinafter may be referred to as “biological information”) regarding the state of tissue or an organ (hereinafter may be referred to as a “target part”) in a living organism that is a test target organism. Here, the test target organism is an animal that is a mammal or any other vertebrate, for example, and may also be referred to as a “test target animal”. Note that examples of the test target organism are not limited to these, and also include insects, other bugs, etc., and invertebrate animals.

The biological information includes, for example, images captured by the imaging unit and showing the state of the target part, other information, and numerical values. The biological information also includes information (e.g., judgment result) regarding the state of the target part acquired based on those images, information, or numerical values.

The images may be still images or moving images (video). A moving image may be considered to include multiple still images. In addition, there is no limitation on the format of data recorded or output as images.

The expression “(to) output information” or “(to) output information to a device” includes displaying on a display or the like, printing on a medium using a printer or the like, transmitting information to another device via a network, and transferring to subsequent processing in information processing performed in a computer etc.

The camera head 10 of the imaging unit 1 includes a camera module 30 and light sources 40. In the present embodiment, the light sources 40 include, for example, first light source units 41 and second light source units 42 that emit light of wavelengths different from each other. More types of light sources may be used. Further details of the structure of the imaging unit 1 will be described later.

The imaging unit 1 is connected to the image acquisition device 500 via a cable 590. The cable 590 includes, for example, a signal line for communicating with the camera module 30, electrical wires for supplying power for driving the camera module 30 and the light sources 40, and so on. The cable 590 is configured to be flexible, but is not limited to such a configuration.

The image acquisition device 500 is, for example, a device including a computer or the like and configured to be capable of driving the camera head 10 of the imaging unit 1 to capture images. In the present embodiment, the image acquisition device 500 is configured to be capable of recording imaging results and outputting the imaging results to an external terminal device 600 or the like and displaying them on a display of the terminal device 600 or the like. The image acquisition device 500 may have its own display and may be configured to be capable of displaying captured images. The image acquisition device 500 may be, for example, a personal computer itself or the like. In the present embodiment, the imaging system 1000 may be understood to include the terminal device 600.

In the present embodiment, the image acquisition device 500 includes, for example, a storage unit 510, an acceptance unit 530, an image acquisition unit 540, a camera head driving unit 550, a communication unit 560, and a power source 570.

The power source 570 supplies power to each unit in the image acquisition device 500 to drive those units. Also, the power source 570 serves as the source of power supplied to the imaging unit 1. For example, the power source 570 is a battery, but is not limited thereto. A configuration is also possible in which the imaging unit 1 includes a battery or the like or power is supplied from another power source to the imaging unit 1.

The storage unit 510 is preferably a non-volatile recording medium, but may also be realized as a volatile recording medium. Each piece of information acquired by the image acquisition device 500 is stored in the storage unit 510. The process in which information or the like is stored is not limited to any specific process. For example, information or the like may be stored via a recording medium, information or the like transmitted via a communication line or the like may be stored, or information or the like input via an input device may be stored. Information may be temporarily accumulated in the storage unit 510.

Note that the storage unit 510 may be realized using a removable recording medium. In this case, the recording medium may be removed from the image acquisition device 500 and information stored in the storage unit 510 may be read by an external device or the like.

The acceptance unit 530 accepts imaging results from the camera head 10, information or the like received by the communication unit 560, etc., as information input to the image acquisition device 500. The accepted information is accumulated temporarily or for a long time in the storage unit 510, or is used in processing by the other units.

Note that the acceptance unit 530 may be capable of accepting information input from an input unit. The input unit may be any input unit, such as a numeric keypad, a keyboard, a mouse, or a menu screen. In this case, the acceptance unit 530 can be realized by a device driver for the input unit such as a numeric keypad or a keyboard, or control software or the like for a menu screen.

The image acquisition unit 540 acquires images captured by the camera head 10. That is, imaging results acquired by the camera module 30 of the camera head 10 and transmitted to the image acquisition device 500 via the cable 590 are acquired as images. The image acquisition unit 540 is configured to be capable of recording the acquired images in the storage unit 510.

The camera head driving unit 550 is configured to supply power to the camera module 30 and the light sources 40 of the camera head 10 to drive each unit and control the operation of each unit.

The image acquisition unit 540 and the camera head driving unit 550 are configured to be operable by, for example, a computer executing a predetermined control program, but are not limited to such a configuration.

The communication unit 560 connects the image acquisition device 500 to an external device so as to be capable of communicating with each other. The communication unit 560 is realized by, for example, a wireless or wired communication unit, but may also be realized by a unit for receiving broadcast or a broadcasting unit. In the present embodiment, the communication unit 560 is configured to be capable of communicating with the external terminal device 600 or the like, for example, and transmitting images that are imaging results of the camera head 10 to the terminal device 600. That is to say, the image acquisition device 500 is capable of outputting images captured using the camera head 10.

The image acquisition unit 540 may also be configured to be capable of acquiring information by performing predetermined information processing and recording the acquired information in the storage unit 510. For example, the image acquisition unit 540 may be configured to acquire biological information based on information acquired by the imaging unit 1. For example, if information processing corresponding to an object of observation is automatically performed, and biological information acquired through the information processing is accumulated or transmitted to an external device, the user can efficiently perform the observation or the like.

Next, the structure of the imaging unit 1 according to the present embodiment will be described.

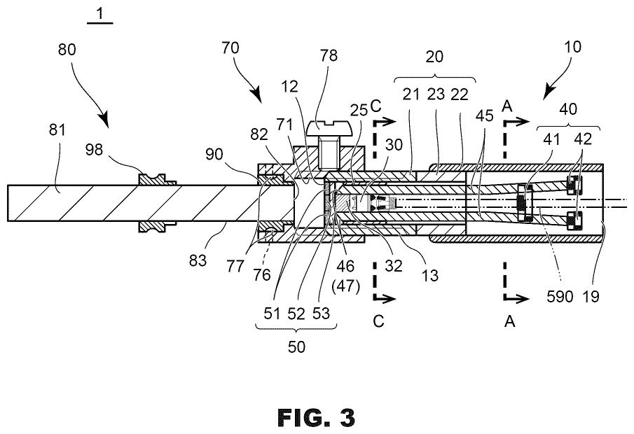

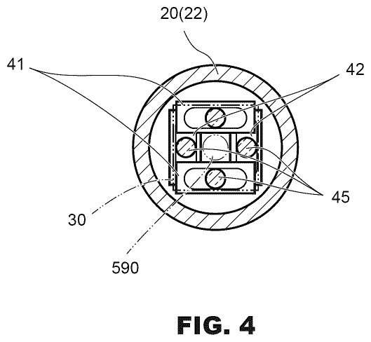

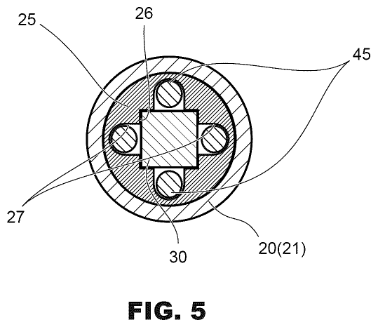

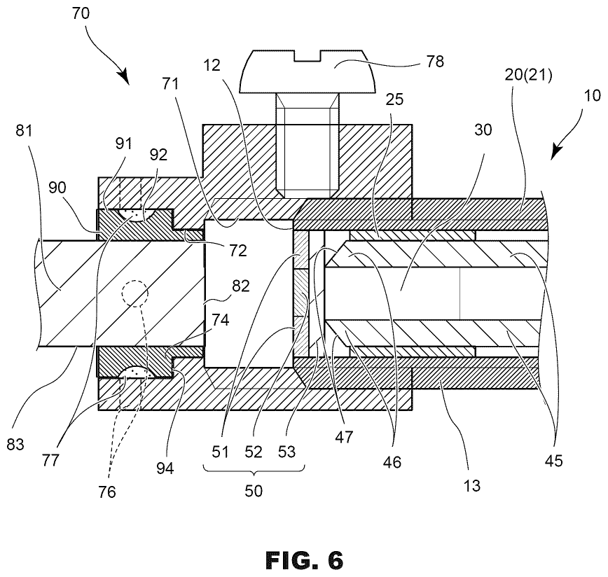

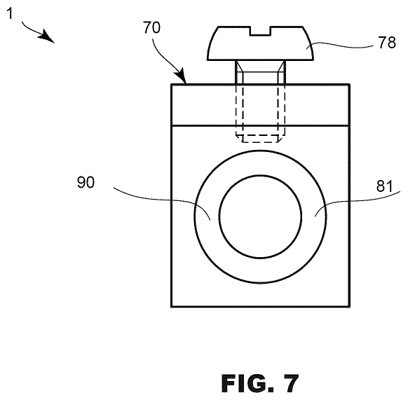

FIG. 3 is a cross-sectional side view of the imaging unit 1. FIG. 4 is a cross-sectional view taken along the line A-A in FIG. 3. FIG. 5 is a cross-sectional view taken along the line C-C in FIG. 3. FIG. 6 is an enlarged cross-sectional side view of the vicinity of a joint portion 70 of the imaging unit 1. FIG. 7 is a diagram illustrating the imaging unit 1 as viewed from the leading end side in the longitudinal direction.

In these figures and similar cross-sectional views below, hatching indicates cross-sections of members, but for ease of illustration, cross-sections of not all members are necessarily hatched.

A summary of the structure of the imaging unit 1 is as follows.

The imaging unit 1 includes the camera head 10, the joint portion 70, and an optical element 80. As shown in the figures, the imaging unit 1 has an overall elongated shape. The optical element 80 is attached to a leading end portion 12 of the camera head 10 in the longitudinal direction (the left-right direction in FIG. 3) via the joint portion 70. That is to say, the leading end portion 12 of the camera head 10 is on the side close to the optical element 80 and is configured such that light from the optical element 80 enters the leading end portion 12 and light is emitted from the leading end portion 12 toward the optical element 80.

In the present embodiment, a male thread 13 is formed around the leading end portion 12 of the camera head 10. The leading end portion 12 is disposed in an attachment portion 71 provided inside the joint portion 70. The attachment portion 71 is provided with a female thread that mates with the male thread 13, and the camera head 10 is joined to the joint portion 70 by screwing the male thread 13 into the attachment portion 71.

The joint portion 70 is configured such that the optical element 80 can be fixed to the joint portion. The optical element 80 is fixed to the joint portion 70 and is aligned with the camera head 10 in the longitudinal direction.

In the present embodiment, the optical element 80 is configured using a gradient-index (GRIN) lens 81. The gradient-index lens 81 has a cylindrical shape. That is to say, the gradient-index lens 81 is a member extending in the longitudinal direction and adjusts an optical path between an observation target and the imaging unit. The optical element 80 is disposed such that the longitudinal direction (axial direction) of the gradient-index lens 81 is the same as the longitudinal direction of the imaging unit 1. In the present embodiment, the optical element 80 may be regarded as an element including the gradient-index lens 81 and other accompanying members (e.g., a fixing member 90).

The gradient-index lens 81 is fixed to the joint portion 70 via the fixing member 90 as described later. The gradient-index lens 81 is disposed such that a lens rear end portion 82 that is an end surface on the side opposite to the side facing an observation target in the longitudinal direction faces the leading end portion 12 of the camera head 10. In the present embodiment, most of a lens side surface 83 of the gradient-index lens 81 is exposed to the outside.

The following describes a specific structure of the camera head 10.

The camera head 10 has an overall elongated shape. In the present embodiment, the camera head 10 as a whole has a substantially cylindrical shape. Note that the camera head 10 may have a prism shape, or may have partial projections and recesses. FIG. 3 can be said to show a cross-section taken along a plane passing through the central axis of the camera head 10.

The camera head 10 includes, for example, a housing 20, the camera module 30, the light sources 40, optical fibers 45, a filter 50, and a guide 25.

The housing 20 is formed into a hollow cylindrical shape. It may be said that the housing 20 is formed into a tubular shape. There is no restriction on the material of the housing 20. Any material such as metal, ceramic, or resin may be used. Each unit of the camera head 10 is housed in the housing 20. It may be said that each unit of the camera head 10 is located inside the housing 20. It may also be said that each unit of the camera head 10 is located inside the inner circumferential surface of the housing 20 in the radial direction (the direction toward or away from the central axis of the camera head 10). The inner circumferential surface of the housing 20 has a cylindrical shape.

In the present embodiment, the housing 20 as a whole has a cylindrical shape including two portions with different diameters in the longitudinal direction. The housing 20 is formed such that the leading end portion 12 side portion, in which the male thread 13 is formed, has a smaller outer diameter than the portion behind. Note that the outer diameter of the housing 20 may be substantially the same in the longitudinal direction. The housing 20 may include a portion having a rectangular tube shape or a portion having projections, recesses, or the like, for example.

In the present embodiment, the housing 20 includes a first tube portion 21 and a second tube portion 22. The first tube portion 21 is close to the leading end portion 12. The first tube portion 21 has a tubular shape. The male thread 13 is formed on the outer circumferential surface of the first tube portion 21. The second tube portion 22 is close to a rear end portion 19 on the side opposite to the leading end portion 12. The second tube portion 22 has a tubular shape. The outer diameter of the second tube portion 22 is larger than the outer diameter of the first tube portion 21. The inner diameter of the second tube portion 22 is larger than the inner diameter of the first tube portion 21. The light sources 40 are disposed inside the second tube portion 22 as described later.

In the present embodiment, the housing 20 includes a heat insulating portion 23. The heat insulating portion 23 is disposed between the first tube portion 21 and the second tube portion 22. The heat insulating portion 23 is formed at a position that is closer to the rear end portion 19 than the first tube portion 21 is. In the longitudinal direction, the first tube portion 21, the heat insulating portion 23, and the second tube portion 22 are arranged in this order to constitute the housing 20.

The heat insulating portion 23 is made of a material that has a thermal conductivity lower than the thermal conductivity of the second tube portion 22. Also, in the present embodiment, the thermal conductivity of the material of the heat insulating portion 23 is lower than the thermal conductivity of the first tube portion 21. Specifically, the first tube portion 21 and the second tube portion 22 are each made of metal, and the heat insulating portion 23 is made of resin, ceramic, or the like, for example. Therefore, when compared with a case where the entire housing 20 is made of a material having a high thermal conductivity, such as metal, for example, heat is unlikely to be conducted from the second tube portion 22 to the first tube portion 21. Thus, it is possible to prevent heat generated in the light sources 40 and the like from having an influence on a target part to be imaged using the imaging unit.

In the present embodiment, the first tube portion 21, the heat insulating portion 23, and the second tube portion 22 are formed separately from each other. These members are assembled by being bonded to each other, for example, to form the single housing 20. For example, the first tube portion 21 and the heat insulating portion 23 are formed to have roughly the same inner diameter and the same outer diameter, and are joined to form a single cylinder. The second tube portion 22 is formed to have an inner diameter slightly larger than the outer diameter of the heat insulating portion 23. The second tube portion 22 is joined to the heat insulating portion 23 with the leading end portion 12 side portion of the second tube portion 22 covering the rear end portion 19 side portion of the heat insulating portion 23.

Note that the configuration of the housing 20 is not limited to this configuration, and the heat insulating portion 23 and at least one of the first tube portion 21 and the second tube portion 22 may be assembled by being molded as a single piece, for example. Alternatively, a configuration is also possible in which a base material is formed integrally using a different material only for a portion corresponding to the heat insulating portion 23, and the housing 20 is formed by subjecting the base material to cutting or the like. It is also possible to form the heat insulating portion 23 having insertion portions that are open on both the leading end portion 12 side and the rear end portion 19 side, and insert the tube portions 21 and 22 into the respective openings to form the single housing 20.

Note that a configuration is also possible in which the housing 20 does not include the heat insulating portion 23. In such a case, the housing 20 may be formed by processing a single base material or tubular member, or may be molded, for example.

The camera module 30 is a module in which an imaging element and an optical system such as a lens are packaged. For example, a module having a known structure can be used as the camera module 30. The camera module 30 has a structure in which a light receiving unit 32, which is located on the leading end side and into which light to be captured enters, the optical system including the lens, etc., and the imaging element are lined up in the longitudinal direction of the camera head 10. Wires (not shown) connected to the imaging element are connected to a rear end portion of the camera module 30, i.e., a rear end portion of the imaging element. The wires can be bundled into the cable 590 and connected to the image acquisition device 500 or the like.

In the present embodiment, the camera module 30 as a whole has a rectangular prism shape formed such that the longitudinal direction of the camera head 10 corresponds to the height direction. That is to say, the outer surface (the circumferential side surface) of the camera module 30 is constituted roughly by four flat portions that are substantially flat. Note that the camera module 30 is not limited to having a rectangular prism shape, and may be formed to have a triangular column shape or another polygonal column shape. The camera module 30 may also be cylindrical or have another shape.

The light sources 40 are the source of light with which an imaging area is irradiated when imaging is performed using the camera head 10. Each light source 40 is, for example, an LED chip, but is not limited thereto. For example, each light source 40 may be another type of light source, such as a laser diode. For example, electrical wires (not shown) passed through the cable 590 are connected to the light sources 40, and the light sources 40 are configured to illuminate when power is supplied from the image acquisition device 500 or the like. Each light source 40 has a rectangular parallelepiped shape, for example, but is not limited to having such a shape, and may have another shape, such as a cylindrical shape, a coin shape, a flat plate shape, or the like.

The camera head 10 includes two or more light sources 40. For example, in the present embodiment, four light sources 40 are provided. Two of the four light sources 40 are the first light source units 41, and the other two are the second light source units 42. Each of the first light source units 41 and the second light source units 42 is, for example, an LED chip having a substantially rectangular parallelepiped shape as a whole and is disposed to emit light from the front surface thereof. The first light source units 41 and the second light source units 42 are configured to emit light of wavelengths different from each other. In the present embodiment, the first light source units 41 and the second light source units 42 are provided, so that it is possible to simplify the structure of the optical fibers 45 that guide light from each light source unit forward. In addition, it is possible to easily adjust the amount of light emitted from the camera head 10 for each wavelength.

Note that the number of light sources 40 is not limited to the number mentioned above. It is sufficient that two or more light sources 40 are provided. Of the two or more light sources 40, at least two are preferably configured to emit light of wavelengths different from each other, as in the present embodiment. For example, the camera head 10 may be provided with one first light source unit 41 and one second light source unit 42. Note that the present invention is not limited to such a configuration and may have a configuration in which the first light source units 41 and the second light source units 42 emit light of the same wavelength. Alternatively, it is also possible to adopt a configuration in which one light source 40 or two or more light sources 40 that emit light of the same wavelength are provided, and the light emitted from the light source(s) 40 is passed through filters that allow light within wavelength bands different from each other to pass therethrough so that light of two or more wavelengths can be emitted from the camera head 10.

As shown in the figure, each light source 40 is disposed at a position farther from the leading end portion 12 than the camera module 30 is in the longitudinal direction. That is to say, each light source 40 is on the rear side with respect to the camera module 30. It may be said that each light source 40 is behind the camera module 30 when viewed from the front (the leading end portion 12 side) of the camera head 10 in the longitudinal direction. In the present embodiment, most of the camera module 30 is disposed inside the first tube portion 21, and the light sources 40 are disposed inside the second tube portion 22. Since the light sources 40 are located away from the leading end portion 12 and the heat insulating portion 23 is provided in the housing 20, heat generated in the light sources 40 is unlikely to be conducted to the leading end portion 12 and is prevented from affecting the subject. In addition, each light source 40 is disposed at a position where a portion of the light source 40 overlaps the camera module 30 when viewed from the front in the longitudinal direction. As a result, each unit of the camera head 10 can be housed in the housing 20 with a smaller diameter.

In addition, in the camera head 10, at least two light sources 40 of the light sources 40 are located at different positions in the longitudinal direction. The rear end of at least one light source 40 of the at least two light sources 40 is located forward of the front end of at least one other light source 40. Since at least two light sources 40 are located at different positions in the longitudinal direction in this manner, the light sources 40 can be housed in the housing 20 with a smaller diameter.

More specifically, in the camera head 10 of the present embodiment, the two first light source units 41 are located forward of the two second light source units 42. In other words, the camera module 30, the two first light source units 41, and the two second light source units 42 are arranged in this order from the leading end portion 12 side in the longitudinal direction. It can be said that the two first light source units 41 are sandwiched between the rear end portion of the camera module 30 and the front end portions of the second light source units 42.

As shown in FIG. 4, in the present embodiment, the two first light source units 41 are disposed radially outside the cable 590 so that the cable 590 is sandwiched between the two first light source units 41. The two second light source units 42 are also disposed radially outside the cable 590 so that the cable 590 is sandwiched between the two second light source units 42. In the present embodiment, the first light source units 41 and the second light source units 42 are disposed so as to partially overlap each other when viewed from the front in the longitudinal direction. Note that the positional relationship between the first light source units 41 and the second light source units 42 when viewed from the front in the longitudinal direction is not limited to the relationship mentioned above. It is preferable that two or more light sources 40 located at different positions in the longitudinal direction are arranged such that the light sources emit light from positions different from each other when viewed from the front in the longitudinal direction. Such an arrangement makes it easy to route the optical fibers 45 as described later.

It is preferable that the rear end portion of the camera module 30 and the first light source units 41, which are the closest to the leading end portion 12 among the light sources 40, are close to each other. In the present embodiment, part of the leading end portion 12 side front surfaces of the light sources 40 that are the closest to the leading end portion 12 faces the rear end portion of the camera module 30 in the longitudinal direction. With such a structure, i.e., a structure in which part of the light sources 40 overlaps the camera module 30 when viewed from the front in the longitudinal direction as shown in FIG. 4, the camera head 10 can be made even smaller.

The optical fibers 45 are disposed radially outside the outer surface of the camera module 30. In the present embodiment, the optical fibers 45 are disposed between the flat portions of the camera module 30 and the inner circumferential surface of the housing 20. The optical fibers 45 guide light emitted from the light sources 40 to the vicinity of the leading end portion 12 so that the imaging area can be irradiated with the light. It can be said that the optical fibers 45 direct the light to the vicinity of the leading end portion 12. It can also be said that the optical fibers 45 guide the light to the vicinity of the leading end portion 12. The vicinity of the leading end portion 12 may include the leading end portion 12.

In the present embodiment, the optical fibers 45 include four optical fibers respectively corresponding to the light sources 40. Note that one light source 40 may be provided with two or more elements, such as optical fibers, that guide light such that the light is emitted from different positions in the radial or circumferential direction.

As shown in FIG. 5, in the present embodiment, the four optical fibers of the optical fibers 45 are disposed around the camera module 30 so as to be spaced apart from each other in the circumferential direction and lined up in the circumferential direction. The optical fibers are arranged at substantially equal intervals in the circumferential direction. That is to say, the four optical fibers are arranged at approximately 90-degree intervals in the circumferential direction.

Here, the optical fibers are disposed along the flat portions of the camera module 30. In the present embodiment, one optical fiber is disposed in each of four spaces between the four flat portions and the inner circumferential surface of the housing 20. As a result of such an arrangement of the optical fibers, each unit of the camera head 10 can be housed in the housing 20 with a smaller diameter, and the camera head 10 can be made smaller in diameter.

In the present embodiment, the guide 25 is disposed in the vicinity of the leading end portion 12 inside the housing 20. The guide 25 is disposed next to the camera module 30 in the longitudinal direction. As shown in the figure, the guide 25 is formed to fill the inside of the housing 20 except for regions where the camera module 30 and the optical fibers 45 are located. That is to say, the guide 25 includes a camera guide portion 26 that is provided substantially at the center and forms a space having substantially the same shape as the cross section of the camera module 30 and fiber guide portions 27 that form spaces at positions through which the four optical fibers 45 are to be passed, respectively. The circumferential surface of the guide 25 has substantially the same shape as the inner wall surface of the first tube portion 21, and the guide 25 is configured to be capable of being housed in the first tube portion 21.

The guide 25 enables positioning of the camera module 30 and the optical fibers 45 in the radial direction. This facilitates the manufacture of the camera head 10 and improves durability of the camera head 10.

In the present embodiment, the filter 50 is disposed in the vicinity of the leading end portion 12 of the camera head 10. Light entering the camera head 10 and light emitted from the camera head 10 pass through the filter 50. The filter 50 includes a first transmitting portion 51 for illumination and a second transmitting portion 52 for imaging, which are provided on a transparent substrate 53. That is to say, the first transmitting portion 51 is provided on the substrate 53, and light emitted from the camera head 10 passes through the first transmitting portion 51. The second transmitting portion 52 is provided on the substrate 53, and light entering the camera head 10 passes through the second transmitting portion 52.

In the present embodiment, the camera head 10 is configured to be capable of being used in bioimaging technology by, for example, irradiating the imaging area with excitation light of a specific wavelength to excite a fluorescent substance and imaging the emitted fluorescence. To enable the camera head 10 to be used for such an application, the second transmitting portion 52 is disposed on the leading end side of the camera module 30, and the first transmitting portion 51 is disposed on the leading end side of the optical fibers 45.

The first transmitting portion 51 is, for example, an excitation light filter. The first transmitting portion 51 allows only light in a specific wavelength range of the light guided by the optical fibers 45 to pass therethrough and irradiates the imaging area with the light. This light acts on and excites fluorescent substances or fluorescent markers in tissue or the like in the imaging area. The second transmitting portion 52 is, for example, a fluorescence filter. The second transmitting portion 52 is configured to allow only fluorescence in a specific wavelength range different from the excitation light to pass therethrough, and allows only a certain fluorescence signal generated after excitation to enter the light receiving unit 32 of the camera module 30 with high precision.

The second transmitting portion 52 is fixed to the camera module 30 so as to cover the front of the light receiving unit 32. The first transmitting portion 51 is disposed in front of the optical fibers 45 so as to have a shape that closes gaps between the second transmitting portion 52 and the inner circumferential surface of the housing 20. That is to say, in the present embodiment, the leading end portion 12 of the camera head 10 is sealed with the filter 50. Note that the rear end portion of the camera head 10 is sealed with a bonding material or the like, for example, but there is no limitation to this configuration.

Note that the filter 50 is not limited to a filter having the properties described above. It is possible to use filters having properties appropriate for their applications. In addition, one or both of the first transmitting portion 51 and the second transmitting portion 52 may be omitted. In this case, the leading end portion 12 may be provided with a filter for protection purposes, or no optical elements may be provided in addition to the camera module 30 and the optical fibers 45. The filter 50 is a so-called optical filter, but may not be an optical filter.

In the present embodiment, each optical fiber 45 includes an inclined portion 47 that is inclined with respect to the longitudinal direction, as an emitting portion 46 in the vicinity of the leading end portion 12. The inclined portion 47 is an end surface of the leading end portion of each optical fiber 45. It can be said that the leading end portion of each optical fiber 45 has an end surface that is cut obliquely, rather than substantially perpendicularly to the direction in which the optical fiber 45 extends. By providing the inclined portion 47 in each optical fiber 45 as described above, the emitting portion 46 of each optical fiber 45 is configured to be capable of emitting at least a portion of light guided from the corresponding light source 40 in a direction different from the longitudinal direction.

In particular, in the present embodiment, each inclined portion 47 is formed to incline rearward to be away from the leading end portion 12 in the longitudinal direction while extending outward from a center portion of the leading end portion 12 in a direction perpendicular to the longitudinal direction. In other words, each inclined portion 47 has a surface that is inclined to be farther from the leading end portion 12 in the longitudinal direction as it extends toward the inner circumferential surface of the housing 20 in the radial direction. It may also be said that each inclined portion 47 is inclined to be closer to the leading end portion 12 as it extends toward a center portion of the camera head 10. Owing to this configuration, a relatively large amount of light flux is emitted outward in the radial direction from the emitting portion 46 of each optical fiber 45. That is to say, the emitting portion 46 is configured to be capable of emitting light, which has been guided from the corresponding light source 40, outward mainly in the radial direction.

Note that a configuration is also possible in which the emitting portion 46 does not include the inclined portion 47, but includes an optical member configured to be capable of dispersing light or has a shape different from the shape of the inclined surface to be capable of emitting light, which has been guided from the corresponding light source 40, mainly in a direction different from the longitudinal direction. Alternatively, a configuration is also possible in which the emitting portion 46 is not provided, and light is emitted mainly in the longitudinal direction from the end surface of each optical fiber 45.

Next, the following describes configurations of the joint portion 70 and the optical element 80.

In the present embodiment, the joint portion 70 includes the attachment portion 71 to which the camera head 10 is attached and a fixing portion 72 to which the optical element 80 is attached. As shown in FIG. 7, in the present embodiment, the joint portion 70 has a substantially cubic shape, but there is no limitation to this configuration. For example, the joint portion may have a spherical shape or a cylindrical shape. The joint portion 70 is made of metal, for example, but may also be made of other materials such as engineering plastics.

The attachment portion 71 is recessed from the side opposite to the side to which the optical element 80 is attached in the longitudinal direction. It may also be said that the attachment portion 71 is a hole in which the leading end portion 12 of the camera head 10 can be housed. A female thread that mates with the male thread 13 on the camera head 10 is formed in the inner circumferential surface of the attachment portion 71. That is to say, the leading end portion 12 of the camera head 10 can be attached to the attachment portion 71 by screwing the male thread 13 into the attachment portion 71.

A fixing screw 78 can be screwed radially inward from a side surface of the joint portion 70. A leading end portion of the fixing screw 78 can protrude to the inner circumferential surface of the attachment portion 71. The camera head 10 can be fixed to the joint portion 70 by screwing the fixing screw 78 so as to come into contact with the vicinity of the leading end portion 12 of the camera head 10 screwed into the attachment portion 71. Note that there is no limitation on the type of the fixing screw 78, and it is possible to use, for example, a stop screw that is a headless screw, or a thumb screw. Alternatively, the fixing screw 78 may be omitted. In this case, the attachment portion 71 and the male thread 13 may be formed such that a certain torque is necessary to rotate the attachment portion and the male thread relative to each other, or a loosening preventive agent or the like may be applied between the threads.

The fixing portion 72 is recessed to be open toward the leading end of the imaging unit 1 in the longitudinal direction. It can be said that the fixing portion 72 is a hole formed such that the fixing member 90 can be fitted thereto as described later. Holes 76 for introducing an adhesive 77 from an outer circumferential portion of the joint portion 70 are formed in the inner circumferential surface of the fixing portion 72.

Also, in the present embodiment, the fixing portion 72 includes a fixing surface 74 that enables positioning of the fixing member 90 in the longitudinal direction. In the present embodiment, the fixing surface 74 is perpendicular to the longitudinal direction. A hole extending to the attachment portion 71 is formed at a center portion of the fixing surface 74.

The female thread in the attachment portion 71 and the fixing portion 72 (including the hole formed at the center portion of the fixing surface 74) are formed coaxially. With this configuration, the gradient-index lens 81 to which the fixing member 90 is attached and that is fixed to the fixing portion 72 and the camera head 10 attached to the attachment portion 71 are arranged coaxially. Therefore, the imaging unit 1 can be easily assembled such that the imaging unit 1 can appropriately emit light and appropriately capture images.

The optical element 80 is configured by attaching the fixing member 90 to the gradient-index lens 81. In the present embodiment, the fixing member 90 is attached to an end portion of the gradient-index lens 81, i.e., an end portion of the optical element 80 on the side close to the camera head 10 in the longitudinal direction. The gradient-index lens 81 and the fixing member 90 can be fixed by being bonded, for example, but there is no limitation to this fixing method.

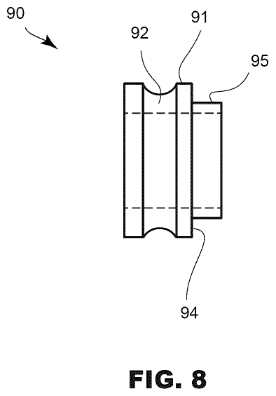

FIG. 8 is a side view of the fixing member 90 of the optical element 80.

As shown in FIG. 8, the fixing member 90 is formed into a cylindrical shape and has a through hole that is formed at the center of the fixing member and into which the gradient-index lens 81 can be inserted. An outer circumferential portion 91 of the fixing member 90 includes a groove portion 92 that is recessed radially inward from the outer circumferential portion 91 and is formed along the entire circumference of the fixing member. A protruding portion 95 whose outer diameter is smaller than that of the outer circumferential portion 91 is formed in an axial direction of the fixing member 90. A contact surface 94 perpendicular to the axial direction is formed between the outer circumferential portion 91 and the protruding portion 95.

The through hole into which the gradient-index lens 81 can be inserted is formed coaxially with the outer circumferential portion 91 or the protruding portion 95. With this configuration, the gradient-index lens 81 and the camera head 10 are coaxially disposed with high precision.

As shown in FIG. 6, the optical element 80 is attached to the joint portion 70 such that the contact surface 94 of the fixing member 90 is in contact with part of the joint portion 70 and the outer circumferential portion 91 faces part of the joint portion 70. The fixing member 90 is fitted into the fixing portion 72. The protruding portion 95 of the fixing member 90 is fitted into the hole formed at the center of the fixing surface 74 and extending to the attachment portion 71. In this state, the fixing member 90 is fixed to the joint portion 70 by being bonded, for example. For example, the fixing member 90 can be fixed to the joint portion 70 by filling gaps between the fixing portion 72 and the outer circumferential portion 91 of the fixing member 90 with the adhesive 77. Note that the adhesive 77 can be introduced from the holes 76 as described later, and the fixing member 90 can be easily fixed to the joint portion 70. The adhesive 77 can fill a gap between the groove portion 92 of the fixing member 90 and the inner circumferential surface of the fixing portion 72, and accordingly, the fixing member 90 can be reliably fixed to the joint portion 70.

Here, the inner diameter of the inner circumferential surface of the fixing portion 72 and the outer diameter of the outer circumferential portion 91 of the fixing member 90 are set to be approximately the same. The inner diameter of the hole at the center of the fixing surface 74 and the outer diameter of the protruding portion 95 may be set to be approximately the same. With this configuration, the gradient-index lens 81 and the camera head 10 are coaxially disposed with high precision.

In the present embodiment, the contact surface 94 of the fixing member 90 faces the fixing surface 74 of the fixing portion 72. The fixing member 90 is fixed to the joint portion 70 with the contact surface 94 held in contact with the fixing surface 74. Therefore, it is possible to reliably assemble the fixing member 90 to the joint portion 70 such that the fixing member 90 is located at a predetermined position relative to the joint portion 70 in the longitudinal direction.

Here, it is desirable to control the length of the protruding portion 95 in the axial direction, i.e., the length from the contact surface 94 to an end of the protruding portion 95 in the axial direction to a predetermined length with relatively high precision. In this case, it is possible to set the position of the lens rear end portion 82 relative to the joint portion 70 with high precision by controlling the positional relationship between the end of the protruding portion 95 and the lens rear end portion 82, which can be positioned relatively easily when fixing the gradient-index lens 81 to the fixing member 90. Also, it is possible to easily reduce an error in the position of the lens rear end portion 82 in the manufacture of multiple assemblies each constituted by the joint portion 70 and the optical element 80.

A stopper 98 is attached to the optical element 80. The stopper 98 is fixed to a predetermined position on the gradient-index lens 81 relative to the leading end portion of the imaging unit 1 by being bonded, for example. In the present embodiment, the stopper 98 is provided to position the imaging unit 1 relative to a test target organism. Note that the stopper 98 may be omitted.

In the present embodiment, the stopper 98 has the same shape as the fixing member 90. That is to say, identical components can be used as the fixing member 90 and the stopper 98. Note that there is no limitation to this configuration, and it is also possible to use a stopper 98 having a suitable shape.

Here, the filter 50 in the present embodiment is configured as described below, for example.

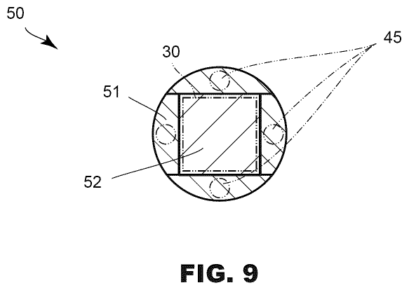

FIG. 9 is a diagram illustrating the configuration of the filter 50 of the camera head 10.

In the present embodiment, the filter 50 is formed into a disk shape to cover the opening of the leading end portion 12 of the housing 20. The second transmitting portion 52 is disposed at a center portion of the filter 50 to cover the leading end side of the camera module 30. Also, the first transmitting portion 51 is disposed around the second transmitting portion 52 to cover the leading end of each optical fiber 45. Note that properties of the first transmitting portion 51 may differ between regions corresponding to the first light source units 41 and regions corresponding to the second light source units 42.

It is possible to easily assemble the camera head 10 by using the filter 50 formed as a single component by forming the first transmitting portion 51 and the second transmitting portion 52 on the same substrate 53.

Here, the camera head 10 can be made extremely small so as to have an outer diameter of about 1 mm to 2 mm, for example. The filter 50 used in such a small camera head 10 is small. The small filter 50 can be manufactured as follows, for example.

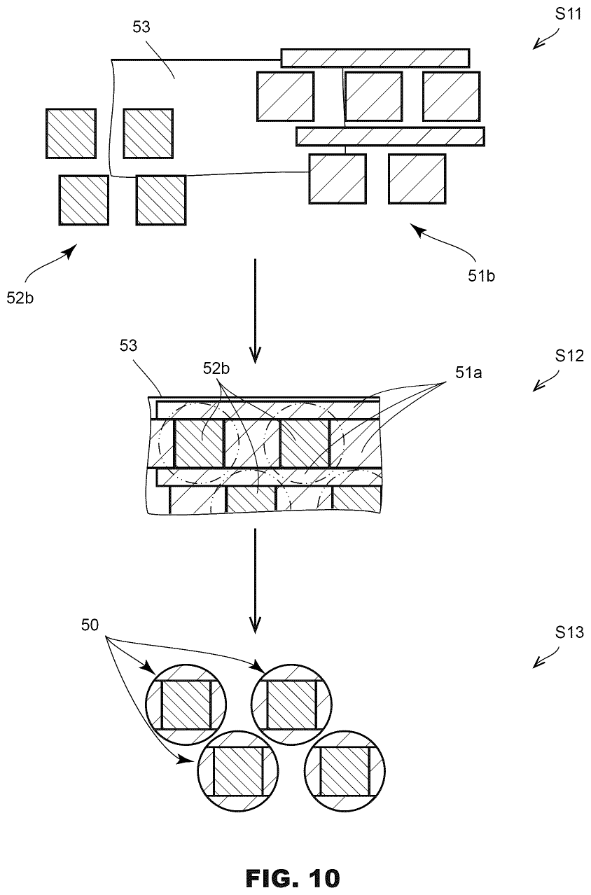

FIG. 10 is a diagram illustrating an example of a method for manufacturing the filter 50.

(Step S11) First, a member (referred to as a “first member 51b”) including the first transmitting portion 51 and a member (referred to as a “second member 52b”) including the second transmitting portion 52 are prepared. Also, a transparent substrate 53 that is sufficiently larger than the filter 50 is prepared.

Note that the first member 51b and the second member 52b may have sizes that allow these members to be handled easily in the manufacture of the filter. The first member 51b and the second member 52b can be easily prepared by coating transparent plates or films or by performing vapor deposition or the like on the plates or films, for example.

(Step S12) Next, the first member 51b and the second member 52b are partially disposed on the transparent substrate 53. In this case, the first member 51b and the second member 52b may be disposed in accordance with the positional relationship between the first transmitting portion 51 and the second transmitting portion 52 in the finished filter 50 (shown by dashed double-dotted lines in the figure), for example.

(Step S13) Then, the substrate 53 on which the first member 51b and the second member 52b are disposed is cut into the shape of the filter 50.

Thereafter, the filter 50 cut out is disposed in the vicinity of the leading end portion 12 of the camera head 10 to manufacture the camera head 10.

As described above, it is possible to easily manufacture the small filter 50 sectioned into the first transmitting portion 51 and the second transmitting portion 52 with high yield.

Note that the method for manufacturing the filter 50 is not limited to this method. For example, layers corresponding to the first transmitting portion 51 and the second transmitting portion 52 may be partially formed at predetermined positions on a substrate 53 made of glass or the like, using a method such as vapor deposition. In this case, in order to section the filter 50 into regions in which the respective layers are formed in the manufacturing process, it is possible to use photolithography and successively perform photoresist coating, pattern exposure, and etching, for example, but there is no limitation to this method.

Next, the following describes a method for manufacturing the imaging unit 1 according to the present embodiment.

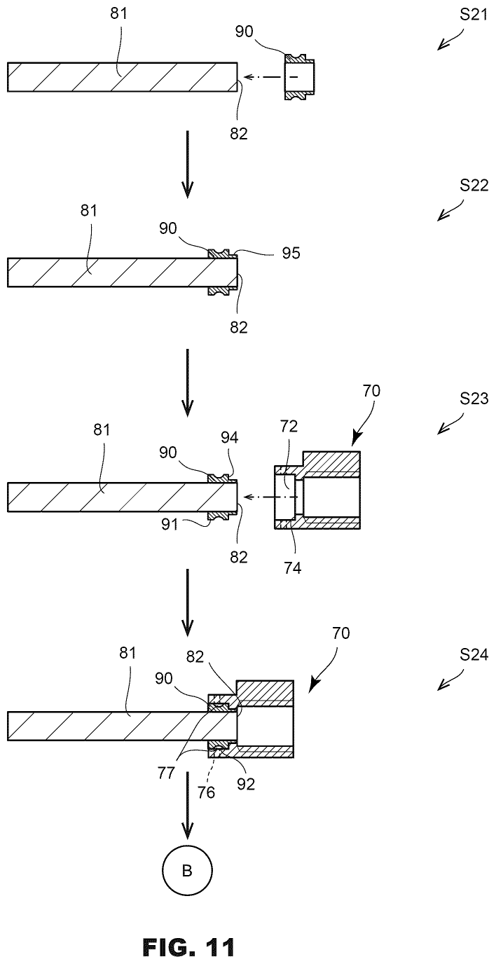

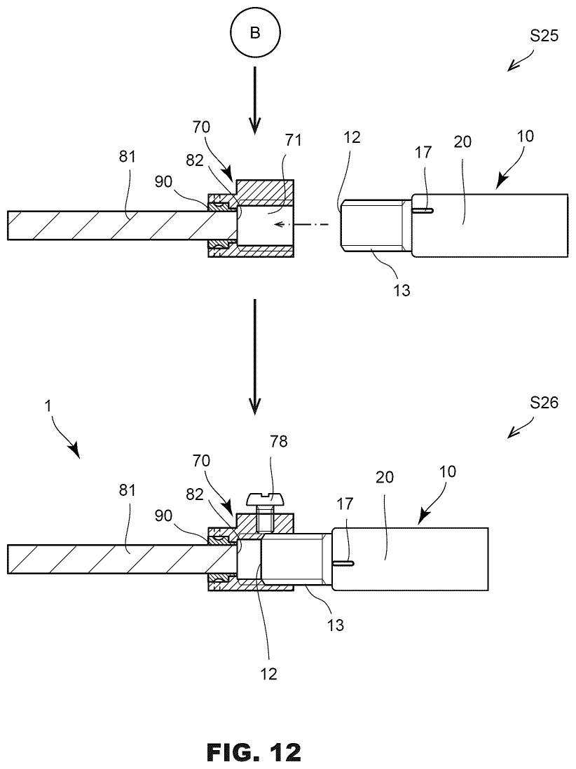

FIG. 11 is a first diagram illustrating the method for manufacturing the imaging unit 1. FIG. 12 is a second diagram illustrating the method for manufacturing the imaging unit 1.

First, the optical element 80 is assembled. That is to say, the fixing member 90 is fixed to an end portion of the gradient-index lens 81 (step S21). At this time, it is desirable that a predetermined positional relationship be satisfied between the fixing member 90 and the gradient-index lens 81 by setting the lens rear end portion 82 to the position of the end of the protruding portion 95 of the fixing member 90, for example (step S22).

Next, the optical element 80 is fixed to the joint portion 70. That is to say, the optical element 80 is attached to the joint portion 70 by fitting the fixing member 90 into the fixing portion 72 (step S23). Then, the adhesive 77 is introduced from the holes 76 in the joint portion 70 into the gap between the joint portion 70 and the groove portion 92 in the state where the outer circumferential portion 91 of the fixing member 90 is located inside the joint portion 70 and the fixing surface 74 is in contact with the contact surface 94 (step S24). Thus, the fixing member 90 is fixed to the joint portion 70.

Next, the camera head 10 is fixed to the joint portion 70. That is to say, the leading end portion 12 of the camera head 10 is screwed into the attachment portion 71 of the joint portion 70 (step S25). At this time, the position of the camera head 10 relative to the joint portion 70 can be adjusted such that a desired light emitting state or a desired light entering state can be achieved between the optical element 80 and the camera head 10. Then, the camera head 10 is fixed at a suitable position relative to the joint portion 70 using the fixing screw 78 (step S26). Thus, the camera head 10 can be attached to the joint portion 70.

The positional relationship between the leading end portion 12 of the camera head 10 and the lens rear end portion 82 is important to capture images in focus and appropriately emit light. Since the camera head 10 and the joint portion 70 are joined with the threads, it is possible to easily adjust the positional relationship by rotating the camera head 10 about the axis relative to the joint portion 70. Also, since the camera head and the joint portion are joined with the threads, it is possible to control a change in the positional relationship with relatively high precision according to the pitch of the threads. For example, when the camera head 10 and the joint portion 70 are separated from each other and then assembled again, it is possible to easily reproduce the state prior to the separation by assembling them with the same screwing amount as that prior to the separation.

In the present embodiment, a marking may be provided on at least one of the housing 20 of the camera head 10 and the joint portion 70 to check the screwing amount or record information of the screwing amount so that the screwing amount can be easily controlled.

For example, as shown in FIG. 12, a marking 17 may be provided in a part in the circumferential direction on the outer circumferential surface of the housing 20. This makes it easy to accurately know how many turns the camera head 10 has been rotated relative to the joint portion 70 when the camera head 10 is screwed into the joint portion 70.

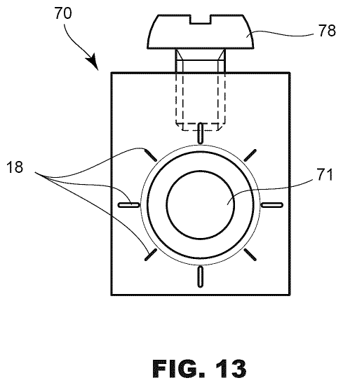

FIG. 13 is a diagram illustrating the joint portion 70 of the imaging unit 1 as viewed from a rear end side in the longitudinal direction.

Alternatively, as shown in FIG. 13, it is possible to provide markings 18 lined up along the circumferential direction around the attachment portion 71 of the joint portion 70, for example. This makes it easy to accurately know how many turns the camera head 10 has been rotated relative to the joint portion 70 by screwing the camera head 10 into the joint portion 70 while checking a positional relationship between the markings 18 and the marking 17 on the camera head 10 or a characteristic part of the camera head 10.

Note that the positions and configuration of the markings are not limited to those described above.

Next, the following describes a use example of the imaging system 1000 in which the imaging unit 1 is used.

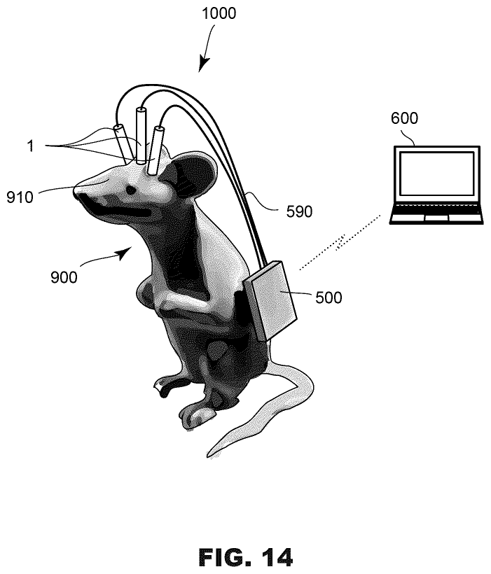

FIG. 14 is a diagram illustrating a use example of the imaging system 1000 according to the present embodiment.

FIG. 14 shows a use example of a case in which an image showing the state of tissue of a test target organism 900 is acquired using the imaging system 1000. Here, the test target organism 900 is a rodent, for example, and is specifically, a mouse. In this use example, the imaging system 1000 is used to observe activities of a specific part of the brain of the mouse. For example, the leading end portion of the imaging unit 1 is inserted to the vicinity of the observation target part of the brain, and an imaging result is acquired by emitting light for observation toward the observation target part and capturing an image of the observation target part.

For such an application, a small imaging unit 1 is used. For example, the imaging unit 1 is configured to have a diameter as small as about 1 mm to 2 mm and have a light weight, and a thin gradient-index lens 81 is used as a portion to be inserted into the living organism. By using such a small imaging unit 1, it is possible to perform minimally invasive observation of the test target organism 900.

In the present embodiment, the image acquisition device 500 is configured to have a small size and a relatively light weight, and be capable of being held on the test target organism 900.

By using such an imaging system 1000, it is possible to perform observation and acquire imaging results from three imaging units 1 in a state where leading end portions of the three imaging units 1 are embedded in the living organism and the image acquisition device 500 connected to the imaging units 1 via cables is held on the test target organism 900. The observation can be continuously performed in a minimally invasive state for the test target organism 900 without significantly hindering ordinary activities of the test target organism 900. Therefore, this configuration allows experiments to be performed under conditions and in observation patterns that are difficult to achieve with conventional large camera heads.

Note that the imaging system 1000 in the present embodiment can be used together with an external terminal device 600, but there is no limitation to this configuration. The terminal device 600 is a so-called server device, for example, but may also be a common personal computer, a smartphone, a tablet terminal, or the like, or a server device. If the image acquisition device 500 is configured to be capable of performing wireless communication, it is desirable that the terminal device 600 be configured to be capable of transmitting and receiving information by wirelessly communicating with the image acquisition device 500. The image acquisition device 500 includes, for example, an attachable and detachable removable medium as a storage unit for storing information, and information may be acquired by the terminal device 600 or the like via the removable medium.

In this use example, each imaging unit 1 can be attached to the test target organism 900 as described below, for example.

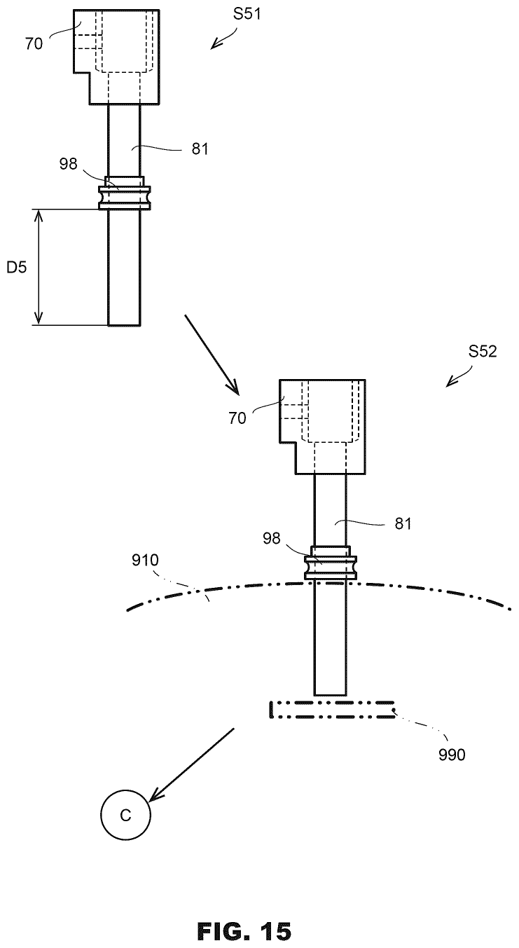

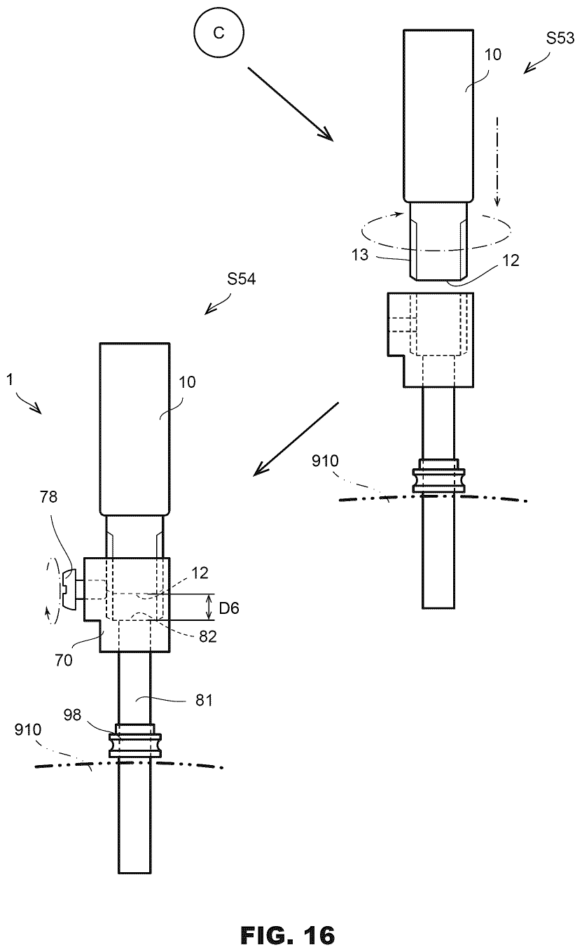

FIG. 15 is a first diagram showing an example of a method for attaching the imaging unit 1 to the test target organism. FIG. 16 is a second diagram showing the example of the method for attaching the imaging unit 1 to the test target organism.

(Step S51) First, the joint portion 70 to which the optical element 80 has been fixed is prepared. Then, the stopper 98 is fixed to a position spaced apart from the leading end portion of the optical element 80 rearward by a predetermined distance D5. The predetermined distance D5 can be set such that the leading end portion of the optical element 80 will be located at a desired position (depth) when the stopper 98 is located at a predetermined position relative to the test target organism 900.

(Step S52) Next, the optical element 80 is attached together with the joint portion 70 to the test target organism 900. Here, the optical element 80 can be attached to the test target organism 900 such that the stopper 98 is located at the predetermined position relative to the test target organism 900.

For example, assume a case where an observation target part 990 is present at a predetermined depth from an outer layer 910 of the skin of the test target organism 900. In this case, the predetermined distance D5 from the leading end portion of the optical element 80 to the stopper 98 is set according to the depth of the observation target part 990 from the outer layer 910 of the skin, and the stopper 98 is fixed in advance. Then, the optical element 80 is inserted into tissue of the test target organism 900 such that the stopper 98 approaches the outer layer 910 of the skin, and thus, it is possible to easily position the leading end portion of the optical element 80 at a position appropriate for imaging the observation target part 990.

Note that, in the state where the optical element 80 has been attached to the test target organism 900 as described above, for example, the stopper 98 may be fixed to the outer layer 910 of the skin or any other part with an adhesive (not shown) to prevent the imaging unit 1 from falling off the test target organism 900.

(Step S53) Next, the camera head 10 is fixed to the joint portion 70. That is to say, the leading end portion 12 of the camera head 10 is screwed into the attachment portion 71 of the joint portion 70 as in step S25 described above. Then, the position of the camera head 10 relative to the joint portion 70 is adjusted such that a desired light emitting state or a desired light entering state can be achieved between the optical element 80 and the camera head 10.

(Step S54) In the state where the camera head 10 is located at an appropriate position relative to the joint portion 70, i.e., a distance D6 between the leading end portion 12 of the camera head 10 and the lens rear end portion 82 is appropriate, the position of the camera head 10 relative to the joint portion 70 is fixed with the fixing screw 78 as in step S26 described above. Thus, the imaging unit 1 can be attached to the test target organism 900 such that the observation can be performed.

As described above, in the present embodiment, the distance between the camera head and the optical element 80 can be adjusted with high precision, and the imaging unit 1 can be easily handled.

The camera head 10 and the joint portion 70 are connected with the threads, and therefore, the imaging unit can be easily disassembled to make the adjustment again, and is flexibly adaptable to different observation conditions and different environments. Furthermore, this structure makes it possible to perform cleaning and maintenance of the imaging unit 1 by disassembling the imaging unit, and accordingly, the imaging unit can be used for a long period of time. For example, even if there is a stain on a sensor portion of the camera head 10 or the surface of the optical element 80, it is possible to immediately disassemble and clean the imaging unit to maintain observation accuracy.

Moreover, the imaging unit 1 is configured such that the camera head 10 is separable from the optical element 80 that is close to an observation target. Accordingly, attachment to the test target organism 900 or the like can be performed using an easy and reliable procedure. For example, even when the observation target is a small animal or the observation needs to be performed in a narrow body cavity, it is possible to attach the imaging unit efficiently and safely by attaching the optical element 80 first, and thereafter attaching the camera head 10. Also, depending on the observation method, it is possible to dispose of the optical element 80 and the joint portion 70 while reusing the camera head 10, for example, and therefore, it is possible to perform the observation multiple times with low cost. Furthermore, this structure makes it possible to adapt the imaging unit to different observation methods and different conditions by replacing only the optical element 80, and therefore, the imaging unit can be used flexibly. For example, it is possible to observe different types of fluorescence using the same camera head 10 by replacing the optical element 80 to those corresponding to different wavelengths. Moreover, the optical element 80 is replaceable, and accordingly, it is possible to easily improve the observation accuracy or introduce a new observation technique by using an optical element that is specially designed for a specific observation target. Furthermore, if the optical element 80 is disposed of after the observation, hygiene risks can be reduced and the safety can be improved particularly in medical applications.

The inclined portion 47 is provided in the emitting portion 46 of each optical fiber 45, and therefore, light that has been guided from the light sources 40 can be effectively dispersed in the radial direction to uniformly irradiate the entire observation target. With this configuration, it is possible to uniformly illuminate a large observation area while avoiding concentration of the light in a specific direction, leading to suppression of unevenness of an image and improvement in the observation accuracy. In particular, the inclined portion 47 is inclined outward in the longitudinal direction relative to the center portion of the leading end portion 12, and therefore, a light flux is efficiently dispersed toward the outer circumferential portion of the camera head 10, and the observation target can be uniformly irradiated with the light. This can be realized with the simple structure, and accordingly, the imaging unit 1 can be made small and the production cost can be suppressed to be low.

### Embodiment 2

The following describes a summary of Embodiment 2 of the present invention, focusing on differences from Embodiment 1 described above. In Embodiment 2, an imaging unit 201 that has the same configuration as the imaging unit in Embodiment 1 except for the following portions is used. The imaging unit according to the present embodiment includes a guide member that is disposed in the vicinity of a rear end portion of the gradient-index lens 81 and configured to cause a portion of light emitted from the leading end portion 12 of a camera head 210 to enter the side surface of the gradient-index lens 81. Also, multiple light sources 40 are disposed in series in the longitudinal direction. Also, the camera head 210 that includes a housing 220 having a substantially straight tube shape is used. Filters 250 are provided separately on paths corresponding to the light sources 40 and the camera module 30.

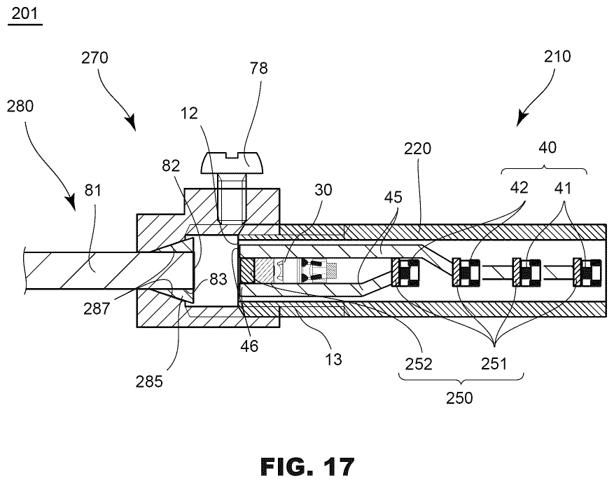

FIG. 17 is a cross-sectional side view of the imaging unit 201 according to Embodiment 2 of the present invention.

As shown in FIG. 17, the imaging unit 201 includes the camera head 210, a joint portion 270, and an optical element 280.

The camera head 210 includes the housing 220 extending in the longitudinal direction and having a constant outer diameter. The male thread 13 is formed on the leading end portion 12 side of the housing 220. This makes it possible to attach the camera head 210 to the attachment portion 71 of the joint portion 270.

Four light sources 40 are housed in the camera head 210 and lined up in the longitudinal direction. That is to say, two first light source units 41 and two second light source units 42 are disposed at different positions respectively behind the camera module 30. Optical fibers 45 are routed from the respective light sources 40 to the vicinity of the leading end portion 12. By adopting such a layout of the light sources 40, it is possible to configure the camera head 210 having a smaller diameter.

In Embodiment 2, the filter 50 is not provided, but four first filters 251 are disposed between the light sources 40 and the corresponding optical fibers 45, respectively, and a second filter 252 is disposed such that light entering the camera module 30 passes through the second filter. With this group of filters 250, it is possible to emit light and capture images similarly to Embodiment 1 described above.

Note that each filter 250 can be cut out from a large member, but there is no limitation to this manufacturing method. It is possible to easily prepare the filters 250 when compared with a case where the small filter 50 integrally including different types of transmitting portions is configured.

The optical element 280 according to Embodiment 2 does not include the fixing member 90 of the optical element 80 described above. The optical element 280 includes the gradient-index lens 81 and a guide member 285 that is provided in the vicinity of the lens rear end portion 82 of the gradient-index lens.

A through hole is provided at the center of the guide member 285 such that the gradient-index lens 81 extends through the through hole. The guide member 285 is attached to the gradient-index lens 81 such that the lens rear end portion 82 is exposed from part of a rear end surface of the guide member 285.

The outer circumferential surface of the guide member 285 has the same axis as the central axis of the gradient-index lens 81, for example, and constitutes part of a cone surface having a generatrix that intersects with the central axis on the leading end side with respect to the lens rear end portion 82. That is to say, in a cross-sectional side view, the guide member 285 has a shape whose length in the radial direction becomes longer as it extends toward the lens rear end portion 82 in the longitudinal direction. The guide member 285 is formed from a transparent member that is used for the optical element, for example, but there is no limitation to this configuration.

The optical element 280 is fixed to the joint portion 270 such that a rear end portion of the guide member 285 and the lens rear end portion 82 are exposed to the attachment portion 71. That is to say, light emitted from the leading end portion 12 of the camera head 210 also enters the guide member 285 from the rear end portion of the guide member 285. The light that has entered the guide member 285 passes through the inside of the guide member 285 to be incident on the lens side surface 83 or reflects off the outer circumferential surface of the guide member 285 inward to be incident on the lens side surface 83. That is to say, it can be said that the guide member 285 has a reflecting portion 287 that is the outer circumferential surface of the guide member 285. Light that has entered the guide member 285 from the rear of the guide member 285 is reflected radially inward by the reflecting portion 287 in a portion of the gradient-index lens 81 forward of the lens rear end portion 82 in the axial direction.

Note that the reflecting portion 287 may be a portion configured to totally reflect light entering from behind or a portion coated to have a mirror surface to reflect a larger amount of light, for example.

Owing to the reflecting portion 287, not only light emitted via the lens rear end portion 82 but also light emitted toward portions radially outward of the lens rear end portion can be emitted from the leading end of the optical element 280 via the gradient-index lens 81. This configuration enlarges a light incident area and makes it possible to appropriately use light from the light sources 40 while making the imaging unit 201 small. In particular, light is efficiently concentrated on the lens side surface 83 by the reflecting portion 287, and this improves the uniformity of light emitted toward the observation target and makes it possible to acquire clear and detailed images.

### (Others)

In the embodiments described above, each component of the image acquisition device may be constituted by dedicated hardware, or components that can be realized with software may be realized by executing a program. For example, each component can be realized by a program execution unit such as a CPU reading and executing a software program recorded on a recording medium such as a hard disk or a semiconductor memory. During execution, the program execution unit may execute the program while accessing a storage unit or a recording medium. The program may be downloaded from a server or the like and executed, or a program recorded on a predetermined recording medium (for example, an optical disk, a magnetic disk, a semiconductor memory, or the like) may be read out and executed. In addition, this program may also be used as a program constituting a program product.

In addition, in the embodiments described above, the transfer of information between the components may be performed, for example, by one component outputting the information and the other component receiving the information if the two components transferring the information are physically different, or, if the two components transferring the information are physically the same, the transfer of information between the components may be performed by transitioning from a processing phase corresponding to one component to a processing phase corresponding to the other component.

In addition, in the embodiments described above, information related to the processing performed by each component, for example, information accepted, acquired, selected, generated, transmitted, or received by each component and information such as thresholds, formulas, addresses, etc., used by each component in its processing may be stored temporarily or for a long period of time on a recording medium (not shown), even if not explicitly stated in the above description. The accumulation of information in the recording medium (not shown) may be performed by each component or by an accumulation unit (not shown). The reading of information from the recording medium (not shown) may be performed by each component or by a reading unit (not shown).

The present invention is not limited to the embodiments described above, and various modifications are possible, which are also included within the scope of the present invention.

The components of the embodiments and modifications described above may be combined as appropriate to form an embodiment. For example, each of the components of the embodiments and modifications described above may be replaced or combined with components of other modifications or the like as appropriate. In addition, some of the components or functions of the embodiments and modifications described above may be omitted.

The image acquisition device itself may include a display and be configured to be capable of displaying a captured image. The image acquisition device may be a personal computer, for example.

A configuration is also possible in which a first light source unit and a second light source unit are disposed at substantially the same position in the longitudinal direction, and another first light source unit and another second light source unit are disposed behind them. Alternatively, the first light source units may be disposed on the rear side and the second light source units may be disposed on the front side. It is sufficient that either one of the first light source units and the second light source units is disposed behind or in front of the other light source units.

The light sources do not necessarily have to be housed in the imaging unit. For example, the light sources may be provided in the image acquisition device, for example, and light guided to the imaging unit via optical fibers or the like may be emitted from the imaging unit. Also, the imaging unit does not necessarily have to be capable of emitting light toward a target part.

A camera head like that described in the above embodiments may be used alone by being attached to a test target organism, i.e., without an optical element being attached to the leading end portion of the camera head. In other words, the camera head can be used alone or used as an imaging unit by attaching the joint portion and the optical element to the camera head. Accordingly, the camera head is highly versatile and can be used for various purposes. In this case, it is preferable to cover the leading end portion of the camera head in a liquid-tight manner using a filter or another optical member, for example.

### INDUSTRIAL APPLICABILITY

As described above, an imaging unit according to the present invention can be used easily and is useful.

### REFERENCE SIGNS LIST

1, 201 Imaging unit
10, 210 Camera head
12 Leading end portion
13 Male thread
20, 220 Housing
21 First tube portion
22 Second tube portion
23 Heat insulating portion
25 Guide
30 Camera module
40 Light source
41 First light source unit
42 Second light source unit
45 Optical fiber
46 Emitting portion
47 Inclined portion
50 Filter
51 First transmitting portion
52 Second transmitting portion
53 Substrate
70 Joint portion
71 Attachment portion
76 Hole
77 Adhesive
78 Fixing screw
80, 280 Optical element
81 Gradient-index lens
82 Lens rear end portion
83 Lens side surface
90 Fixing member
91 Outer circumferential portion
92 Groove portion
94 Contact surface
98 Stopper
251 First filter
252 Second filter
285 Guide member
287 Reflecting portion

What is claimed is:

1. An imaging unit comprising:
an optical element that is a gradient-index lens extending in a longitudinal direction and configured to adjust an optical path between an observation target and the imaging unit;
a joint portion fixable to the optical element; and
a camera head including a camera module, a light source disposed behind the camera module, a leading end portion that is close to the optical element and through which light from the optical element enters and light is emitted toward the optical element, and an optical fiber extending from the light source to the vicinity of the leading end portion,
wherein the gradient-index lens, the joint portion, and the camera head are lined up along the longitudinal direction of the gradient-index lens,
a male thread is formed around the leading end portion,
the joint portion includes an attachment portion into which the male thread is screwed,
the leading end portion is disposed inside the joint portion,
the male thread and the attachment portion constitute an adjustment structure for adjusting a positional relationship between the leading end portion and the optical element in the longitudinal direction of the gradient-index lens,
an end surface of a leading end portion of the optical fiber includes an inclined portion that is formed to incline rearward to be away from the leading end portion in the longitudinal direction of the gradient-index lens while extending outward from a center portion of the leading end portion in a direction perpendicular to the longitudinal direction of the gradient-index lens, the inclined portion being configured such that light guided from the light source is emitted from the inclined portion in a direction different from the longitudinal direction of the gradient-index lens, and
the adjustment structure enables adjustment of the positional relationship between the leading end portion and the optical element in the longitudinal direction of the gradient-index lens such that a desired light emitting state or a desired light entering state is achieved between the optical element and the camera head.

2. The imaging unit according to claim 1,
wherein the camera head includes a housing that includes a portion in which the male thread is formed,
each unit of the camera head is housed in the housing, and
the housing includes:
a first tube portion that is a tubular portion close to the leading end portion;
a second tube portion that is a tubular portion close to a rear end portion on the side opposite to the leading end portion and in which at least the light source is disposed; and
a heat insulating portion that is disposed between the first tube portion and the second tube portion and is made of a material having a thermal conductivity lower than a thermal conductivity of the second tube portion.

3. The imaging unit according to claim 1,
wherein the camera head includes a guide that is disposed in the vicinity of the leading end portion and positions the camera module and the optical fiber in a radial direction.

4. The imaging unit according to claim 1,
wherein the camera head includes:
a first filter disposed between the light source and the optical fiber; and
a second filter disposed such that light entering the camera module passes through the second filter.

5. The imaging unit according to claim 1,
wherein the camera head includes a filter that is disposed in the vicinity of the leading end portion and through which light entering the camera head and light emitted from the camera head pass, and
the filter includes:
a transparent substrate;
a first transmitting portion that is disposed on the substrate and through which light emitted from the camera head passes; and
a second transmitting portion that is disposed on the substrate and through which light entering the camera head passes.

6. The imaging unit according to claim 1,
wherein the optical element extends in the longitudinal direction and has a rear end portion and a side surface, and
the optical element includes a guide member that is disposed in the vicinity of the rear end portion of the optical element and configured to cause a portion of light emitted from the leading end portion of the camera head to enter the side surface of the optical element.

7. The imaging unit according to claim 6,
wherein the guide member includes a reflecting portion that reflects light entering from behind inward toward the side surface of the optical element in a portion forward of the rear end portion of the optical element.

8. The imaging unit according to claim 1,
wherein the optical element is a member extending in the longitudinal direction,
the optical element includes a fixing member attached to an end portion of the optical element close to the camera head in the longitudinal direction,
a groove portion is formed in an outer circumferential portion of the fixing member,
the optical element is attached to the joint portion such that a contact surface of the fixing member that is perpendicular to the longitudinal direction and capable of positioning the optical element in the longitudinal direction is in contact with part of the joint portion and the outer circumferential portion faces part of the joint portion, and
an adhesive is disposed between the groove portion and the joint portion.

9. The imaging unit according to claim 1,
wherein the joint portion includes a fixing part capable of being disposed to fix the camera head to the joint portion by coming into contact with the vicinity of the leading end portion of the camera head screwed into the attachment portion.

10. A camera head usable in the imaging unit according to claim 1, the camera head comprising:
a housing; and
a camera module provided in the vicinity of a leading end portion of the housing,
wherein the male thread capable of being screwed into the attachment portion of the joint portion is formed around the leading end portion of the housing.

11. An imaging unit attaching method for attaching the imaging unit according to claim 1 to a non-human test target organism, the method comprising:
fixing the joint portion to the optical element;
attaching the optical element to a non-human test target organism; and
attaching the camera head to the joint portion by screwing the leading end portion of the camera head into the attachment portion of the joint portion.

12. The imaging unit attaching method according to claim 11, further comprising:
fixing a stopper to a position spaced apart from a leading end portion of the optical element rearward by a predetermined distance,
wherein in the attaching the optical element to a non-human test target organism, the optical element is attached to the non-human test target organism such that the stopper is located at a predetermined position relative to the non-human test target organism.

13. The imaging unit attaching method according to claim 11,
wherein a fixing member is attached to an end portion of the optical element,
a groove portion is formed in an outer circumferential portion of the fixing member, and
the fixing the joint portion includes introducing an adhesive between the joint portion and the groove portion from a hole provided in the joint portion in a state where the outer circumferential portion of the fixing member is inside the joint portion.

14. The imaging unit attaching method according to claim 11,
wherein the attaching the camera head to the joint portion includes adjusting a position of the camera head relative to the joint portion such that a desired light emitting state or a desired light entering state is achieved between the optical element and the camera head, and fixing the position of the camera head relative to the joint portion with a fixing part.
